(19) United States
(12) Patent Application Publication
(10) Pub. No.: US 2012/0236351 A1
(43) Pub. Date: Sep. 20, 2012

(54) IMAGE FORMING APPARATUS AND DISPLAY DEVICE

(75) Inventor: Yasuharu ARIMA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/420,504

(22) Filed: Mar. 14, 2012

Related U.S. Application Data
(60) Provisional application No. 61/453,526, filed on Mar. 16, 2011.

(51) Int. Cl. G06K 15/02

(52) U.S. Cl. 358/1.13; 358/1.15

(57) ABSTRACT

An image forming apparatus of the present embodiment is an image forming apparatus that executes a print job registered in a print queue. The image forming apparatus includes: an acquiring section configured to acquire a print job; a controller configured to determine if a print job newly acquired by the acquiring section has a set value giving a priority to making a printed output in a short time, and if the new print job has the set value, to change order of print jobs in the print queue so that the new print job is printed before a print job already accepted and not having the set value; and a printing section configured to perform printing in the order changed by the controller.

### CROSS-REFERENCE TO RELATED APPLICATIONS

This application is based upon and claims the benefit of priority from: US provisional application 61/453526, filed on Mar. 16, 2011; the entire contents all of which are incorporated herein by reference.

### FIELD

Embodiments described herein relate generally to a technique of controlling print order of print jobs, and displaying the statuses of the print jobs.

### BACKGROUND

There has been an image forming apparatus capable of selecting either a print job giving printing with high image quality a higher priority than a time for printing process (hereinafter called an image quality job), or a print job giving a priority to making a printed output in a short time while disregarding an image quality (hereinafter called a time job) when the image forming apparatus performs printing. The image forming apparatus performs a process for image quality adjustment where necessary in response to receipt of an image quality job, and thereafter, performs a printing process of the image quality job.

If a time job is entered into a print queue after entry of an image quality job, a conventional image forming apparatus performs a process for image quality adjustment. This requires the subsequent time job to be placed on standby waiting for its printing for a time corresponding to a time for the process for image quality adjustment.

### DESCRIPTION OF THE DRAWINGS

FIG. 1 is a view showing an exemplary structure of an image forming apparatus;

FIG. 2 is a block diagram of the image forming apparatus;

FIGS. 3A and 3B are views explaining operation for rearrangement of print jobs performed in response to new registration of a time job if a printing section does not perform printing;

FIG. 4 is a view explaining operation for rearrangement of print jobs performed in response to new registration of a time job if a print job to be processed next is a time job;

FIGS. 5A and 5B are views explaining operation for rearrangement of print jobs performed in response to new registration of a time job if the printing section performs printing;

FIG. 6 is a view explaining exemplary operation for rearrangement performed if an inconvenience is caused by the operation for rearrangement shown in FIG. 5B;

FIG. 7 is a flow chart explaining exemplary operation of the image forming apparatus;

FIGS. 8A, 8B and 8C are views showing exemplary lists of print jobs appearing on a control panel; and

FIG. 9 is a view showing an exemplary structure where a list of print jobs appears on a PC and a tablet PC.

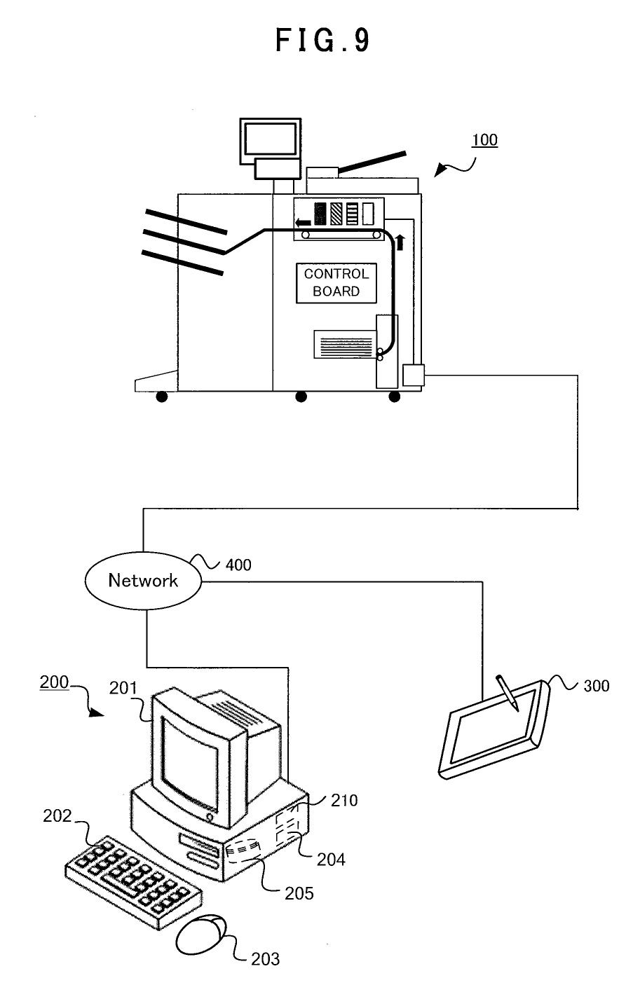

### DETAILED DESCRIPTION

An image forming apparatus of an embodiment is an image forming apparatus that executes a print job registered in a print queue. The image forming apparatus includes: an acquiring section configured to acquire a print job; a controller configured to determine if a print job newly acquired by the acquiring section has a set value giving a priority to making a printed output in a short time, and if the new print job has the set value, to change order of print jobs in the print queue so that the new print job is performed before a print job already accepted and not having the set value; and a printing section configured to perform printing in the order changed by the controller.

A display device of the embodiment is a display device on which a list of print jobs registered in a print queue of an image forming apparatus is displayed. The display device is configured to allow information indicating a status of a first print job and indicating that the first print job is currently being printed, and information indicating a status of a second print job different from the first print job and indicating that the second print job is placed on standby midway through its printing process to be simultaneously displayed in a field of the list indicating statuses of the print jobs.

An embodiment is described below by referring to the drawings.

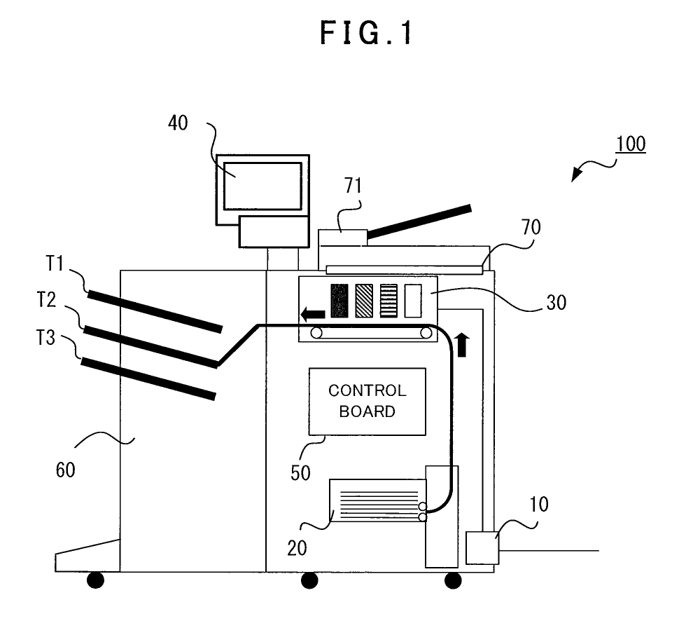

FIG. 1 shows part of the structure of an image forming apparatus of the present embodiment. An image forming apparatus 100 is an MFP (multi-function peripheral) capable of performing copying, scanning, printing, and transmission and receipt by facsimile. The image forming apparatus 100 includes a communication controller 10, a sheet feeding cassette 20, a printing section 30, a control panel 40, a control board 50, a post-processing unit 60, and a scanner unit 70.

The communication controller 10 is a unit that receives print data formed by an external device such as a personal computer (hereinafter abbreviated as a PC). The communication controller 10 of the present embodiment includes a network interface card. The communication controller 10 further includes a FAX board connected to a telephone line or an IP communication line, and performs transmission and receipt by facsimile to and from the outside through a telephone network or an IP communication network. Additionally, the communication controller 10 conforms to the USB (universal serial bus) standard, and is connectable to an external device (such as a PC or a USB memory). The communication controller 10 acquires print data or data for facsimile transmission from an external device, and performs printing or facsimile transmission of the acquired data. Data received by the communication controller 10 is temporarily stored in a storage device 51 (described later).

The sheet feeding cassette 20 is a unit that stores sheets, and feeds the sheets stored therein to a main body part of the image forming apparatus 100. The sheet feeding cassette 20 includes a frame for storing sheets and a pickup roller.

The printing section 30 is a unit that forms an image in C (cyan), M (magenta), Y (yellow), and K (black) on a sheet transferred from the sheet feeding cassette 20. The printing section 30 forms print data acquired by the communication controller 10 or image data read by the scanner unit 70 on a sheet. The printing section 30 has a photosensitive drum, a charging roller and others for each color.

The control panel 40 (display device) is a touch panel display on which the status of the image forming apparatus 100 and the status of a print job are presented to a user, and through which instructions from a user and setting information are acquired. The control panel 40 includes a liquid crystal panel functioning as a display part and a touch pad input device functioning as an input part.

The control board 50 is a board responsible for overall control of respective hardware sections in the image forming apparatus 100. The details of the control board 50 are described later.

The post-processing unit 60 is a unit responsible for a process for tying a batch of sheets on which images are formed together with staples (stapling process), and a process for punching holes in the same position of a plurality of sheets (hole punching process) on the basis of a set value of a print job. Further, the post-processing unit 60 has a plurality of discharge trays T1 to T3. Based on a control signal output from the control board 50, the post-processing unit 60 moves the discharge trays T1 to T3 up and down collectively, and determines which tray is to receive a sheet to be transferred.

The scanner unit 70 is a unit that scans a document sheet placed on a transmissive tray, and converts the document sheet into an electronic form. The scanner unit 70 includes the transmissive tray on which a document to be printed is placed, a light emitting device, and a CCD (charge-coupled device) image sensor. As shown in FIG. 1, the scanner unit 70 may include an automatic document feeder 71.

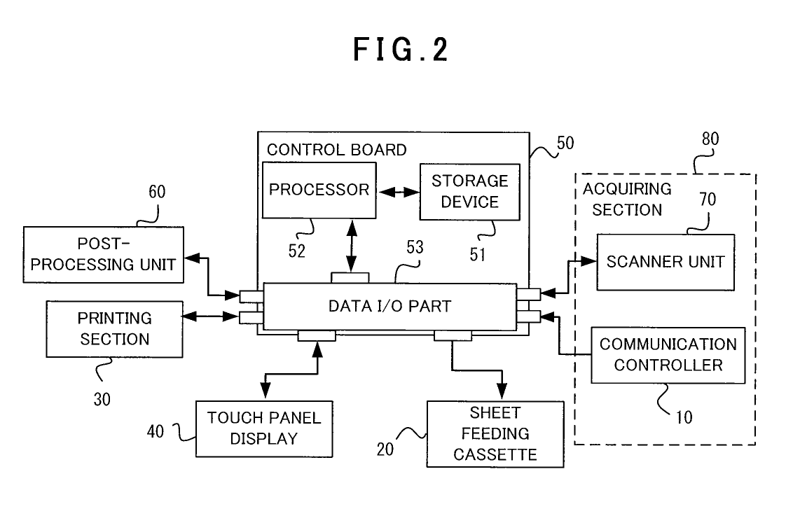

The structure of the control board 50 will be described next by referring to FIG. 2. The control board 50 includes the storage device 51, a processor 52, and a data I/O (input/output) part 53. The storage device 51 is a device that stores an OS (operating system), a program running on the OS, and various data. The storage device 51 is composed of one, or two or more of a RAM (random-access memory), a ROM (read-only memory), a DRAM (dynamic random-access memory), an SRAM (static random-access memory), a VRAM (video RAM), a hard disk drive, and the like. Part of a storage region of the storage device 51 functions as a region for a print queue in which data is stored in an FIFO (first-in first-out) format. A plurality of print jobs are registered in the print queue after they are accepted. In the present embodiment, order of print jobs in a print queue can be manipulated.

The processor 52 is an arithmetic processing unit that executes the OS and the program stored in advance in the storage device 51, and controls each of the hardware sections in the image forming apparatus 100. The processor 52 may be a CPU (central processing unit) or an MPU (micro processing unit), for example. In the present embodiment, a single processor is prepared, and the program is executed and the hardware sections are controlled by the single processor. Meanwhile, the processor 52 may include a plurality of processors prepared according to corresponding substances of execution such as a processor for executing software resources such as the OS and the program, and a processor for outputting a control signal to each of the hardware sections in the image forming apparatus 100. Furthermore, the processor 52 may be formed from an ASIC (application-specific integrated circuit) if applicable.

The data I/O part 53 is a data bus that controls data communications between the hardware sections in the image forming apparatus 100. A control signal or data given from the processor 52 is transmitted through the data I/O part 53 to each of the hardware sections.

Further, the image forming apparatus 100 may include an acquiring section 80 composed of either or both of the scanner unit 70 and the communication controller 10 as shown in FIG. 2.

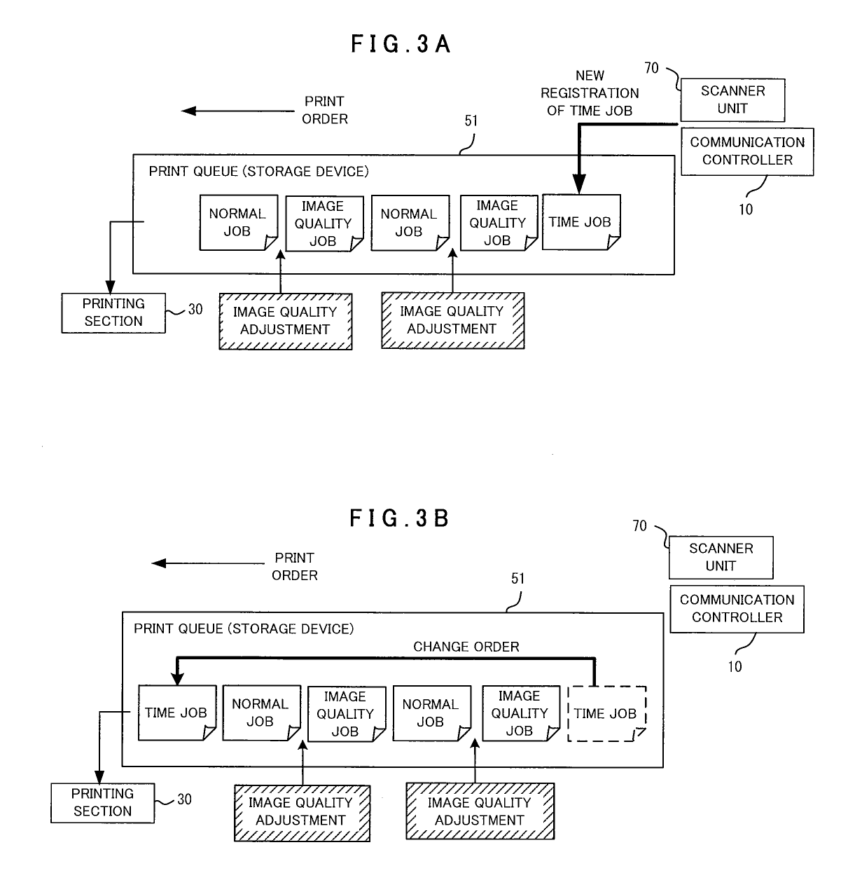

Change of order of print jobs registered in a print queue will be described next by referring to FIGS. 3A to 6. If the image forming apparatus 100 accepts a plurality of print jobs, the image forming apparatus 100 registers the print jobs themselves or data relating to the corresponding print jobs in a print queue, and fetches the print jobs for sequential printing. The print jobs are registered and then fetched in an FIFO format. The control board 50 changes order of the print jobs registered in the print queue according to the rule described below.

Operation for rearrangement of print jobs performed when the printing section 30 does not perform a printing process will be described first by using FIGS. 3A and 3B. Image data scanned by the scanner unit 70 is managed as a print job together with print setting information indicating a sheet size, the number of pages to be printed, the number of sets of pages to be printed, a job type (value indicating a time job or an image quality job), and the like. Print data acquired from the outside through the communication controller 10 is also managed as a print job. After a print job is newly accepted, the control board 50 registers the accepted print job in a print queue at the rear end thereof.

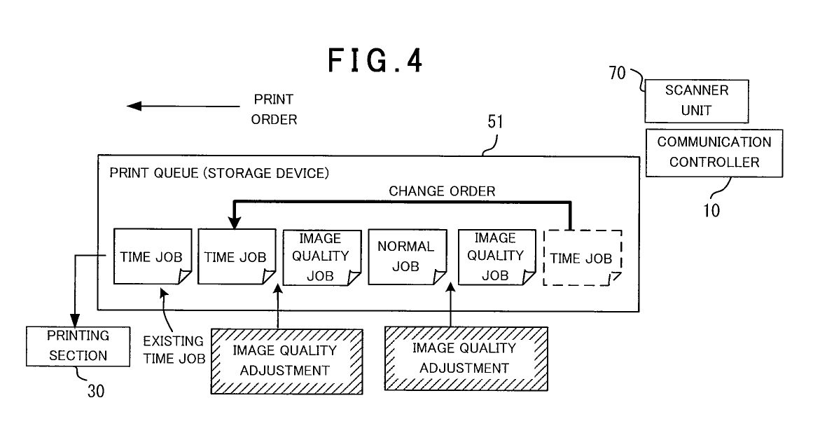

In the example of FIG. 3A, a plurality of normal jobs and a plurality of image quality jobs are already registered in a print queue. In the present embodiment, a normal job is a print job that is neither a time job nor an image quality job. Further, a process for image quality adjustment is performed before an image quality job is processed. The control board 50 makes control such that print jobs are printed in order they are registered in a print queue. However, if a time job is newly registered in the print queue, the control board 50 moves the new time job to the front of the print queue in order for the new time job to be printed next. As a result of such manipulation of the print queue, the time job is printed before image quality adjustment. If a new time job is registered in a print queue that already includes a time job, the control board 50 changes order such that the new time job comes after the existing time job as shown in FIG. 4.

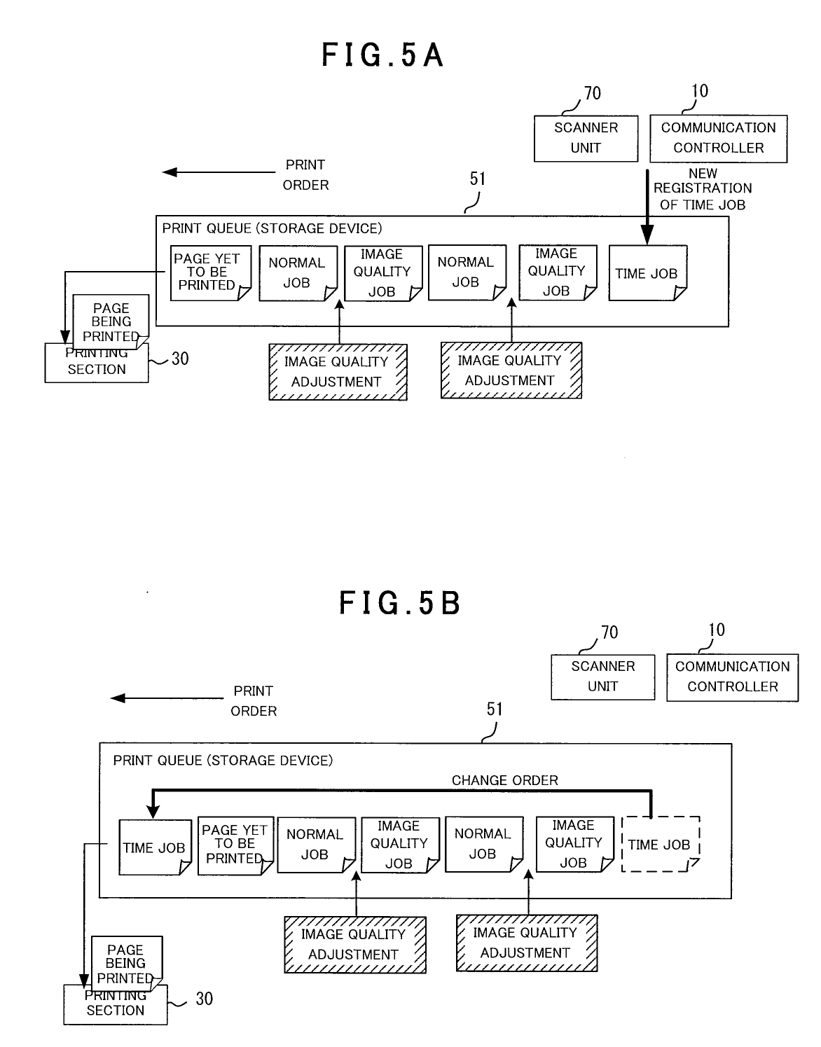

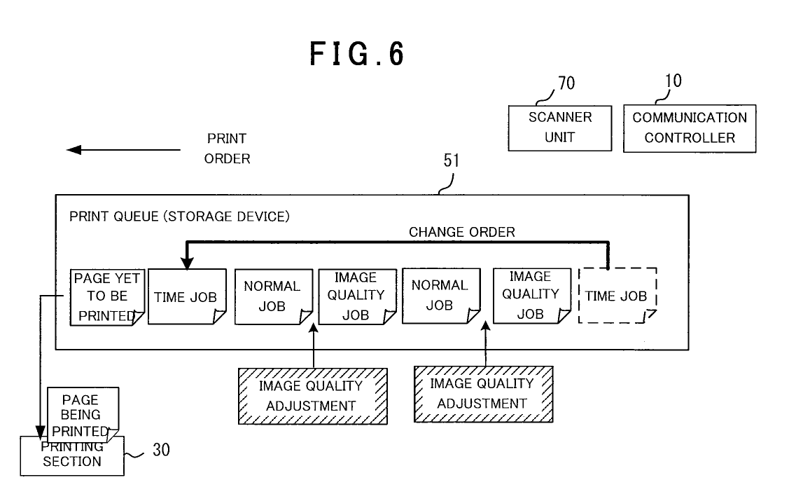

A case where a time job is newly registered in a print queue while the printing section 30 performs printing of a print job at the front of the print queue will be described below by using FIGS. 5A to 6.

As shown in FIG. 5A, if a time job is newly registered when printing of a page currently being printed (“page being printed” shown in FIG. 5A) in an image quality job or a normal job is finished, or while this page is being printed, the control board 50 places the image quality job or the normal job on standby after printing of the page thereof currently being printed is finished. Then, the control board 50 manipulates order in a print queue such that the newly registered time job goes to the front (see FIG. 5B). This manipulation makes the new time job at the front become a print job to be printed next, so that the printing section 30 performs the printing process of this time job. When printing of the new time job is finished, the printing section 30 restarts the print job having been placed on standby to print a page (“page yet to be printed” shown in the examples of FIGS. 5A and 5B) next to the page for which printing has been finished. As described, the control board 50 can interpose a print job between pages in the same print job as well as between print jobs. Further, the printing section 30 can perform printing in the print order determined by the control board 50.

An inconvenience may be caused if a time job is interposed and then printed while a job currently being subjected to printing process is once placed on standby. In this case, the control board 50 does not perform the manipulation of the print queue shown in FIG. 5B, but manipulates order such that a new time job is printed after a print job currently being printed. Specific examples involving the manipulation of FIG. 6 will be described next.

(Case 1) If a job currently being printed is a time job, priority is given not to a time job newly registered but to the job currently being printed. Accordingly, the control board 50 performs the manipulation shown in FIG. 6.

(Case 2) If two of the trays T1 to T3 to receive sheets to be discharged are full of sheets and cannot receive further sheets, and if a job currently being printed is a job involving addition of a staple or a hole, the manipulation shown in FIG. 6 is performed. If a time job becomes an interruption during printing while only one tray can receive sheets to be discharged, the destinations of discharge of a job currently being printed and the time job become the same. In this case, a printed page in the time job is interposed between pages in the job being printed, making it impossible to put a staple or punch a hole. Accordingly, in the present embodiment, if a print job currently being printed is given a value involving a stapling process or a hole punching process, this print job is not interrupted but printing of the job continues until the job is finished. If an image forming apparatus includes only one discharge tray, there is no other tray to receive sheets to be discharged. In this case, if a print job currently being printed by the printing section 30 involves a stapling process or a hole punching process, no suspension and no interruption are made.

(Case 3) If a small number of pages (about one to ten pages) are yet to be printed in a print job currently being printed, or if the print job is to be finished in a short remaining time (in about zero to ten seconds), a time job does not become an interruption but the time job is interposed in a break between jobs (the manipulation shown in FIG. 6 is performed). This prevents reduction of efficiency of productivity caused by switching between jobs. Values indicating the number of pages yet to be printed and a remaining time are determined in advance, and can be determined freely by a user.

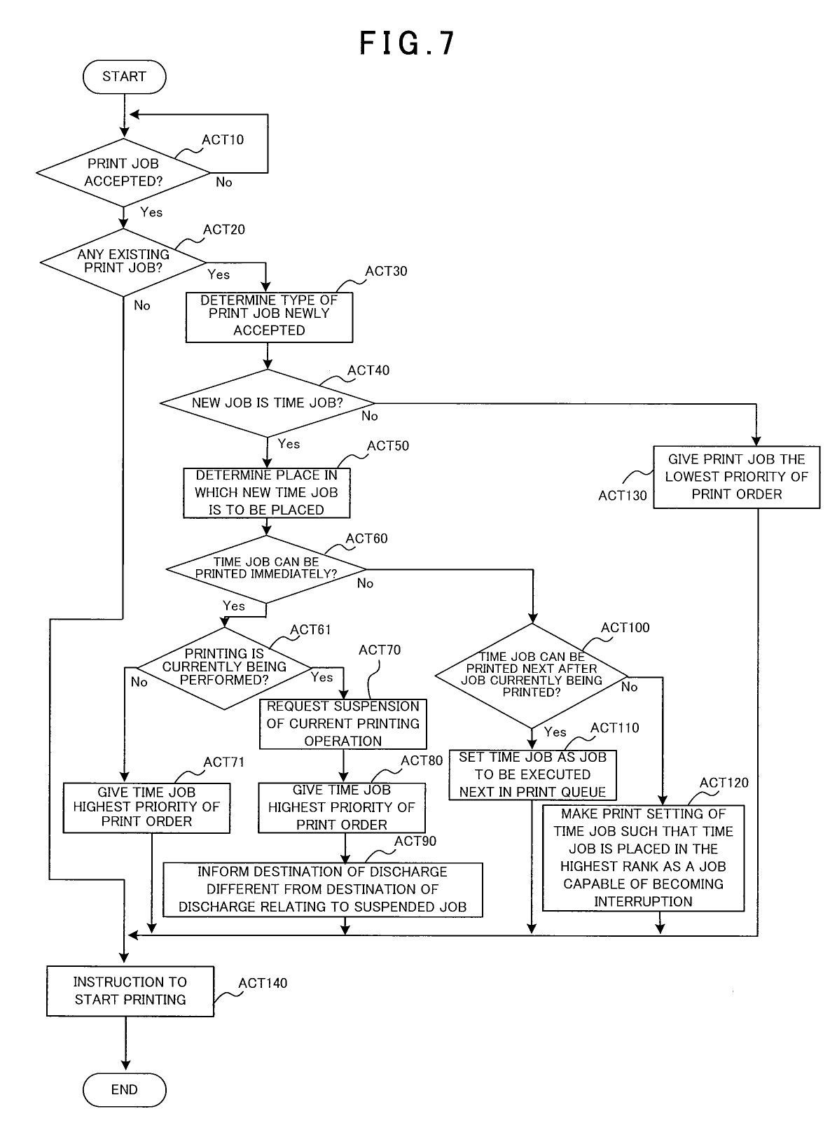

The operation of the image forming apparatus 100 will be described next by referring to the flow chart of FIG. 7. Each of the processes of the flowchart of FIG. 7 is realized by the control board 50. The following description of the processes is based on the assumption that the control board 50 is divided into a high-order system (called SYS) and a low-order system (called M-CPU). The SYS is apart where software and hardware perform a process cooperatively. The M-CPU is a part responsible for control of the hardware. As an example, the M-CPU transmits a control signal to each of the hardware sections in the image forming apparatus 100 in response to instructions from the SYS.

If a new print job is accepted (ACT 10, Yes), the SYS determines if an existing print job is registered in a print queue (ACT 20). If there is no existing print job (ACT 20, No), the SYS instructs the M-CPU to start printing of the print job accepted in ACT 10 (ACT 140).

If there is an existing print job in the print queue (ACT 20, Yes), the SYS determines the type of the accepted print job (ACT 30), and determines if this print job is a time job (ACT 40). In ACT 30 and ACT 40, the SYS determines if the accepted print job is a time job by checking data in setting information about the accepted print job that defines the type of the print job.

If the accepted print job is not a time job (ACT 40, No), the SYS registers this print job in the print queue at the rear end thereof to give the lowest priority of print order to the print job (ACT 130). The SYS thereafter instructs the M-CPU to start printing (ACT 140).

If it is determined in ACT 40 that the accepted print job is a time job (ACT 40, Yes), the SYS determines a place in the print queue in which this time job is to be placed (ACT 50). This determination is made based on if printing process is currently being performed, or if the case 1, 2 or 3 described above applies.

If the time job can be printed immediately (ACT 60, Yes), the SYS determines if the printing section 30 is currently performing printing process (ACT 61). If the printing section 30 is currently performing a printing process (ACT 61, Yes), the SYS requests the M-CPU to suspend the current printing operation (ACT 70). This temporarily suspends the process of a next page to be printed (page next to a page currently being printed). Examples of implementation after the request given in ACT 70 is accepted include a case where the M-CPU may not transmit a signal instructing start of printing of a next page to be printed to the printing section 30, a case where the M-CPU may output a signal instructing suspension of printing to the printing section 30, thereby making the printing section 30 suspend the process of the next page to be printed, and the like.

The SYS changes order in the manner described by using FIG. 5B such that the time job is given the highest priority of print order (ACT 80). Also, in order for the suspended job and the interposed time job not to have the same destination of discharge, the M-CPU selects a tray from the trays T1 to T3 different from a currently used tray in response to instructions from the SYS, and outputs a control signal to the post-processing unit 60 (ACT 90). Next, the process proceeds to ACT 140.

Meanwhile, if printing is not being performed currently (ACT 61, No), the SYS changes order of print jobs in the manner described by using FIG. 3B such that the time job is given the highest priority of print order (ACT 71).

If it is determined in ACT 60 that the new time job cannot be printed immediately (ACT 60, No), the SYS determines if this new time job can come after the job currently being printed (ACT 100). If it is determined that the time job can come after the job currently being printed (ACT 100, Yes), the SYS changes order so that printing of the time job is executed after the job currently being printed (ACT 110). In ACT 110, the manipulation shown in FIG. 6 is performed.

If it is determined in ACT 100 that the new time job cannot come after the job currently being printed (ACT 100, No), the SYS makes the print setting of this time job such that the time job is placed in the highest rank as a job capable of becoming an interruption (ACT 120). As an example, the process in ACT 120 is based on the assumption that one, or a plurality of time jobs already exist in the print queue. There is no order of priority between time jobs. Accordingly, if one time job is already registered, the SYS changes order so that output of the new time job is given after output of the existing time job (see FIG. 4). In addition, if a plurality of time jobs are already registered, the new time job is registered to be placed after the plurality of existing time jobs.

ACT 140 is performed after the print jobs in the print queue are rearranged as described above. After the M-CPU outputs a control signal to start printing in ACT 140, the sheet feeding cassette 20 feeds sheets to the main body part of the image forming apparatus 100. Then, the printing section 30 forms images on the sheets by using the setting information defined in the print jobs and image data stored in the print jobs. If the setting of a print job involves stapling or hole punching, the post-processing unit 60 performs a stapling process or a hole punching process. After the processes described above, printed sheets are discharged to one of the trays T1 to T3.

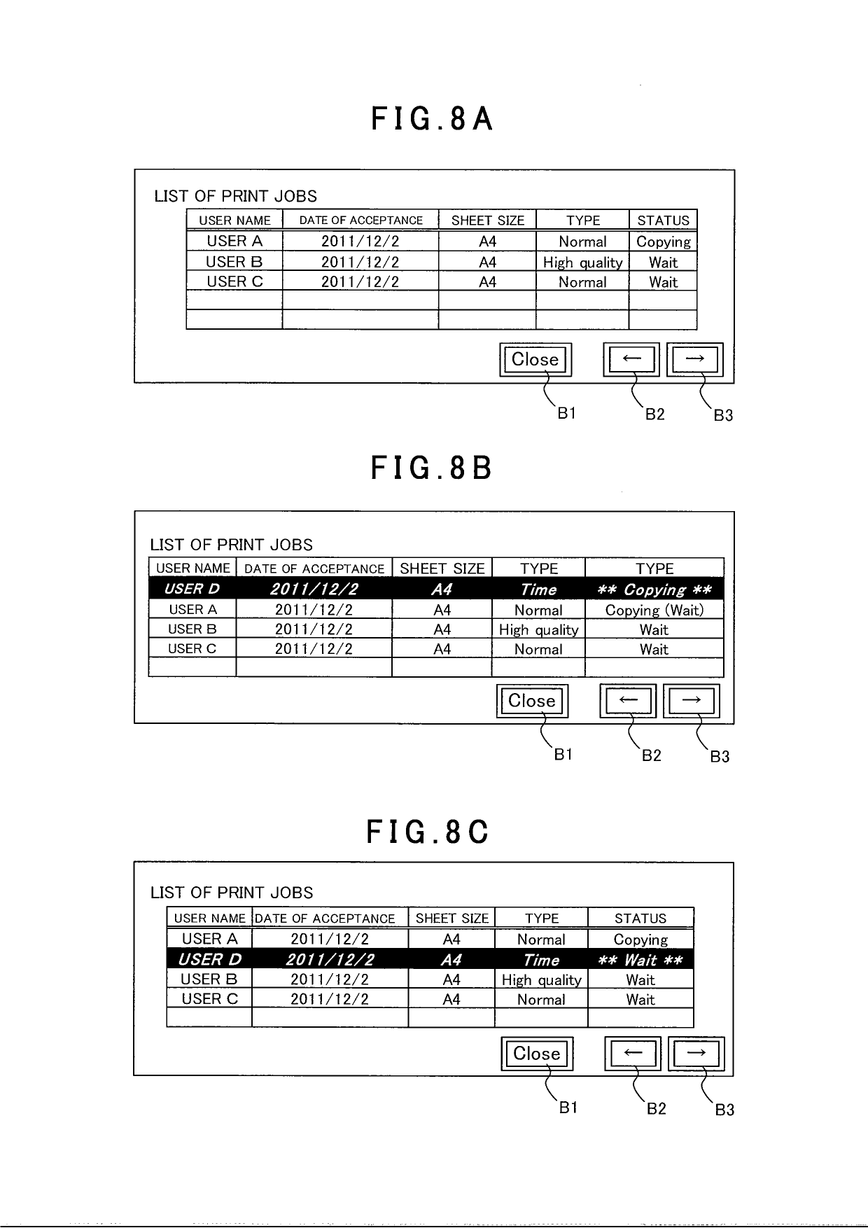

Examples of display on the control panel appearing in response to change of order of print jobs are shown in FIGS. 8A to 8C. In the present embodiment, a record of each print job contains “User name” corresponding to information identifying a user who instructed to execute the print job, “Date of acceptance” corresponding to a date on which the image forming apparatus 100 accepted the print job, “Sheet size,” “Type” indicating if the print job is a time job, an image quality job, or a normal job, and “Status” indicating the current status of the print job, with these items being displayed.

In the present embodiment, “Time” indicating a time job, “High quality” indicating an image quality job, and “Normal” indicating a normal job are displayed in the “Type” field. Further, the following values are displayed in the “Status” field:

“Copying” indicating that a corresponding job is currently being printed, and “**Copying**” that is reversed display of “Copying.”

“Wait” indicating that a corresponding job is on standby, and “**Wait**” that is reversed display of “Wait.”

“Copying (Wait)” indicating that a corresponding job being printed is placed on standby as a result of interruption.

Values in “User name,” “Sheet size,” and “Type” are acquired by referring to setting information in a corresponding print job. A value in “Date of acceptance” is acquired based on a system clock in the image forming apparatus 100. The control board 50 stores a value indicating the current status of each print job. A value in “Status” is displayed in response to acquisition of this value indicating the status.

Items to be displayed are not limited to those shown in FIGS. 8A to 8C. As an example, information identifying a print job, the file name of image data, the number of pages to be printed, the number of sets of pages to be printed, the number of pages yet to be printed, information identifying an external device as a source of transmission, and the like may be displayed in list form.

The control panel 40 also includes a button B1 with which a currently displayed list disappears, and arrow buttons B2 and B3 for change of display operated if all print jobs do not appear in a display region.

FIG. 8A shows an example of display appearing when a plurality of print jobs are registered in a print queue, and a print job of a user A is being printed by the printing section 30. The print job of the user A is being printed, and accordingly, it is indicated as “Copying” in the status field. The remaining print jobs are on standby, so that they are indicated as “Wait” in the status field.

If a time job of a user D is accepted in this condition and the control board 50 performs the manipulation described by referring to FIG. 5B, display on the control panel 40 is changed to the one shown in FIG. 8B.

First, the user name, the status and others of the time job newly registered are displayed in list form. “Copying (Wait)” is displayed in the status field of the print job of the user A to indicate that this print job having been printed by the printing section 30 is placed on standby. “**Copying**” different from generally appearing “Copying” is displayed in the status field of the interposed time job to emphasize the interruption by this time job. Further, in the present embodiment, the record of the interrupting time job is displayed in a reversed style to highlight the interrupting this time job. A way of emphasis is not limited to this, but various other ways may be thought of such as change of the font of characters being displayed to boldfaced or italicized font. Further, the interrupting time job may be displayed at the top as shown in FIG. 8B. Such change of display permutations allows a user to more visually recognize change of order. As shown in FIG. 8B, “**Copying**” and “Copying (Wait)” are displayed at the same time.

Meanwhile, if the aforementioned case 1, 2 or 3 applies, a job currently being printed is not stopped but printing thereof continues as described by using FIG. 6. An example of display at this time on the control panel 40 is shown in FIG. 8C. Printing process of the print job of the user A currently being printed continues, so that “Copying” is still displayed in the status field of this print job. The newly registered time job of the user D is displayed in an emphasized style, and is placed in a second place from the top in order for a user to visually recognize that this time job is to be printed next.

In the description given above, the control panel 40 of the image forming device 100 functions as a display device. Meanwhile, a PC 200 connected to the image forming apparatus 100 through a network 400 may also be used as a display device. The network 400 of the present embodiment is a wired or wireless LAN (local area network). The PC 200 has a structure comparable to that of an existing PC, and includes a CPU 204, a memory 205, a monitor 201, a keyboard 202 and a mouse 203 functioning as an input part, an NIC (network interface card) 210. The lists of print jobs shown in FIGS. 8A to 8C can be displayed on the monitor 201. In order for the lists of FIGS. 8A to 8C to be displayed on the monitor 201, the PC 200 acquires through the NIC 210 information of various types about print jobs stored in the storage device 51 of the image forming apparatus 100, and then allows the acquired information to be displayed on the monitor 201.

The lists of FIGS. 8A to 8C may also be displayed on a tablet PC 300 with a CPU, a memory, a touch panel display, and a communication control unit. A smartphone or a PDA (personal digital assistant) having a structure comparable to that of the tablet PC 300 is also applicable.

As described in detail above, the technique described in the specification is capable of shortening the standby time of a time job.

The technique described in the specification is also capable of notifying a user of generation of change of order of print jobs.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus configured to execute a print job registered in a print queue, comprising:
an acquiring section configured to acquire a print job;
a controller configured to determine if a print job newly acquired by the acquiring section has a set value giving a priority to making a printed output in a short time, and if the new print job has the set value, to change order of print jobs in the print queue so that the new print job is printed before a print job already accepted and not having the set value; and
a printing section configured to perform printing in the order changed by the controller.

2. The image forming apparatus according to claim 1, wherein
if the print job newly acquired by the acquiring section has the set value and if a print job currently being executed by the printing section does not have the set value, the controller transmits a suspension signal to suspend the print job currently being executed by the printing section, and changes print order so that the new print job is executed next, and
the printing section suspends the print job currently being executed if the suspension signal is received.

3. The image forming apparatus according to claim 2, wherein, if the suspension signal is received, the printing section suspends the print job currently being executed after printing of a page thereof currently being printed is finished.

4. The image forming apparatus according to claim 3, wherein, if printing of the new print job having the set value is finished, the printing section restarts the suspended print job to print a page next to the page for which printing has been finished.

5. The image forming apparatus according to claim 1, wherein, if the print job newly acquired by the acquiring section and the print job currently being executed by the printing section have the set value, the controller changes print order so that the new print job is executed after the print job currently being executed.

6. The image forming apparatus according to claim 1, wherein, if the print job newly acquired by the acquiring section has the set value, and if print jobs already registered in the print queue include at least one print job having the set value, the controller changes print order such that the new print job comes after the print job already registered and having the set value.

7. The image forming apparatus according to claim 1, wherein, if the print job newly acquired by the acquiring section has the set value, if the print job currently being executed by the printing section does not have the set value, and if the number of pages yet to be printed of the print job currently being executed is smaller than a predetermined specific value, the controller changes print order so that the new print job is executed next after the print job currently being executed.

8. The image forming apparatus according to claim 1, wherein, if the print job newly acquired by the acquiring section has the set value, if the print job currently being executed by the printing section does not have the set value, and if a remaining process time of the print job currently being executed is shorter than a predetermined specific value, the controller changes print order so that the new print job is executed next after the print job currently being executed.

9. The image forming apparatus according to claim 2, further comprising a plurality of discharges trays, and wherein
the controller also controls such that a tray to receive sheets to be discharged as a result of the new print job and a tray to receive sheets to be discharged as a result of the suspended print job differ from each other.

10. The image forming apparatus according to claim 9, wherein, if only one of the plurality of discharge trays can receive sheets to be discharged, and if the print job currently being executed by the printing section has a set value involving a stapling process or a hole punching process, the controller changes print order so that the new print job is executed next after the print job currently being executed.

11. The image forming apparatus according to claim 1, wherein, if the print job newly acquired by the acquiring section has the set value, and if the print job currently being executed by the printing section has a set value involving a stapling process or a hole punching process, the controller changes print order so that the new print job is executed next after the print job currently being executed.

12. The image forming apparatus according to claim 2, further comprising a display device configured to allow a list of the print jobs registered in the print queue to be displayed on the display device, and to allow information indicating that the new print job is currently being printed and information indicating that the print job having been printed is placed on standby midway through its printing process to be simultaneously displayed in a field of the list indicating the statuses of the print jobs on the display device.

13. The image forming apparatus according to claim 12, wherein the display device allows a record of the new print job and a record of a print job registered in the print queue and different from the new print job to be displayed on the display device in different styles.

14. The image forming apparatus according to claim 12, wherein the display device allows a record of the new print job to be displayed at the top of the list on the display device.

15. A display device configured to allow a list of print jobs registered in a print queue of an image forming apparatus to be displayed thereon, the display device configured to allow information indicating a status of a first print job and indicating that the first print job is currently being printed, and information indicating a status of a second print job different from the first print job and indicating that the second print job is placed on standby midway through its printing process to be simultaneously displayed in a field of the list indicating statuses of the print jobs.

16. The display device according to claim 15, wherein the display device allows a record of the first print job and a record of a print job registered in the print queue and different from the first print job to be displayed in different styles on the display device.

17. The display device according to claim 16, wherein the display device allows the record of the first print job to be displayed in a reversed style on the display device.

18. The display device according to claim 15, wherein the display device allows a record of the first print job to be displayed at the top of the list on the display device.

19. The display device according to claim 15, wherein the display device allows information to be displayed in the list on the display device, the information indicating if a print job is a print job having a set value giving a priority to making a printed output in a short time, a print job having a set value giving a priority to printing with high image quality, or a print job not having either of the set values.

20. The display device according to claim 15, wherein the display device further allows information identifying a user who instructed to execute a print job to be displayed in the list on the display device.
